(19) United States
(12) Patent Application Publication
(10) Pub. No.: US 2005/0177468 A1
(43) Pub. Date: Aug. 11, 2005

(54) Request for quote system and method

(76) Inventors: Kiet Lam, Cypress, CA (US); Joshua Liu, San Gabriel, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/774,156

(22) Filed: Feb. 5, 2004

(51) Int. Cl. G06F 17/60

(52) U.S. Cl. 705/29

(57) ABSTRACT

A request for quote (RFQ) system (10) includes an application server (11), a database server (12) and an RFQ website (14). The application server includes: a data receipt module (110) for receiving RFQ spreadsheets from a customer system (20), and for inquiring of item information in a supplier system (30); a data verification module (111) for determining whether a customer is a new one, and for ascertaining whether all item information specified in the RFQ spreadsheets is available; a data creation module (112) for creating an account for a new customer, and for creating RFQ numbers according to the RFQ spreadsheets; an RFQ report generation module (113) for generating RFQ reports according to the RFQ spreadsheets, the RFQ numbers and corresponding bills of materials; and an RFQ response transmission module (114) for receiving and transmitting responses to the RFQ reports. A related RFQ method is also disclosed.

### BACKGROUND OF THE INVENTION

1. Field of the invention

The present invention relates generally to request for quote (RFQ) systems and methods, and especially to an RFQ system and method through which suppliers of goods and/or services offer quotes via an electronic communications network in response to requests from customers who are interested in purchasing the suppliers' goods and/or services.

2. Description of the related art

Customers in need of goods and/or services often spend considerable time in selecting an appropriate vendor. They generally use trade publications, trade directories, personal recommendations and other means to locate vendors. If a selected vendor is in a foreign country, the problem is compounded. Vendors advertise through various media or by direct sales methods, in order to make known to potential buyers what they sell and how to contact them. Once a buyer identifies a few vendors, each must be contacted in order to obtain product prices, availability and other information. This is a time consuming process, and companies typically rely on experienced purchasing staff to accomplish it. In addition, when buyers need to sell surplus inventory from time to time, they must advertise, cold call, sell to brokers, or try other means. These processes are costly and time consuming for most businesses.

To solve these problems, computerized shopping systems which employ some kind of central database of goods and services offered to buyers have been developed. In such systems, a vendor provides its database of goods and/or services to a buyer, who orders items from the vendor's database through an electronic medium such as a website. The buyer first logs on the website, and offers requests for quote (RFQs) for the goods and/or services to be purchased. The vendor replies to the RFQs, and provides product and pricing information to the buyer. The buyer then determines whether to purchase the goods and/or services from the vendor based on his/her commercial judgment.

The art of processing RFQs is disclosed in publications such as U.S. Pat. No. 5,842,178 issued on Nov. 24, 1998 and entitled Computerized Quotation System and Method. This patent discloses a computerized system for engaging in commercial transactions. The system comprises a filter means for accepting filter conditions from buyers and vendors, a plurality of buyers for communicating RFQs to the filter means, and a plurality of sellers for communicating quotes to the filter means in response to the RFQs. A method for processing RFQs utilizing the computerized system comprises the steps of: receiving a buyer's RFQs over a communication network; selecting one or more appropriate vendors to receive the buyer's RFQs based on filter conditions; transmitting or making available the buyer's RFQs to selected vendors over a communications network; and transmitting quotations from the vendors to the requesting buyer.

U.S. pat. Publication No. 20010037281 entitled Request for Quote (RFQ) System and Method and published on Nov. 1, 2001 discloses a system and method for a customer to obtain a quote for a product online. The customer submits an RFQ on a certain product to an electronic staging area. The quote desirably includes at least one product specification. One or more vendors submit at least one quote to the customer via the staging area in response to the RFQ. Preferably, the RFQ is forwarded to at least two vendors who compete with one another during a specified auction period to provide the customer with the best price quote for the product.

However, the systems described above do not address how to process RFQ spreadsheets submitted by various different customers. RFQ spreadsheets received from one customer may be very different from those received from another customer both in format and content, and the problem of how to efficiently deal with the diverse RFQ spreadsheets is a vexed one. In addition, an RFQ spreadsheet may comprise information on one or more items. If information on any item is not available in a database of a vendor which provides the goods and/or services required by the customer, the vendor generally needs to go to the trouble of inquiring of the item information in a database of the relevant supplier. Existing systems do not disclose how to deal with these situations systematically. What is needed is an RFQ system and method which can overcome the above-described problems.

### SUMMARY OF THE INVENTION

A main objective of the present invention is to provide an RFQ system and method which can generate standard RFQ reports according to RFQ spreadsheets received from various customers and bills of material (BOMs) imported according to customer part numbers comprised in the RFQ spreadsheets.

Another objective of the present invention is to provide an RFQ system and method which can inquire of item information in a corresponding vendor when the item information is not available.

To achieve the above objectives, an RFQ system in accordance with a preferred embodiment of the present invention comprises an application server, a database server, an RFQ website and a plurality of user terminals. The RFQ system is connected with a customer system and a supplier system via an extranet. The application server is interconnected with the database server and the RFQ website through a means of communication.

The application server comprises: a data receipt module for receiving RFQ spreadsheets from the customer system, and for inquiring of item information in the supplier system; a data verification module for determining whether a customer is a new one, and for ascertaining whether all item information specified in the RFQ spreadsheets is available; a data creation module for creating an account for a new customer, and for creating RFQ numbers according to the RFQ spreadsheets; an RFQ report generation module for generating RFQ reports in accordance with the RFQ spreadsheets, the RFQ numbers and BOMs imported according to customer part numbers comprised in the RFQ spreadsheets; and an RFQ response transmission module for receiving responses to the RFQ reports, and for transmitting the RFQ responses to the customer system.

Further, the present invention provides an RFQ method utilizing the above-described RFQ system. The RFQ method comprises the steps of: receiving one or more RFQ spreadsheets from the customer system; determining whether the customer running the customer system is a new one; creating one or more RFQ numbers in the RFQ system according to the RFQ spreadsheets; importing one or more bills of material (BOMs) according to customer part numbers comprised in the RFQ spreadsheets; generating one or more RFQ reports according to the RFQ spreadsheets; and responding to the RFQ reports, and transmitting RFQ responses to the customer system.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware configuration of a request for quote (RFQ) system in accordance with the present invention, together with an application environment of the RFQ system;

FIG. 2 is a block diagram of main function modules of an application server of the system of FIG. 1; and

FIG. 3 is an exemplary flow chart of a preferred RFQ method utilizing the system of FIG. 1.

### DETAILED DESCRIPTION OF THE PREFERRED EMBODIMENT

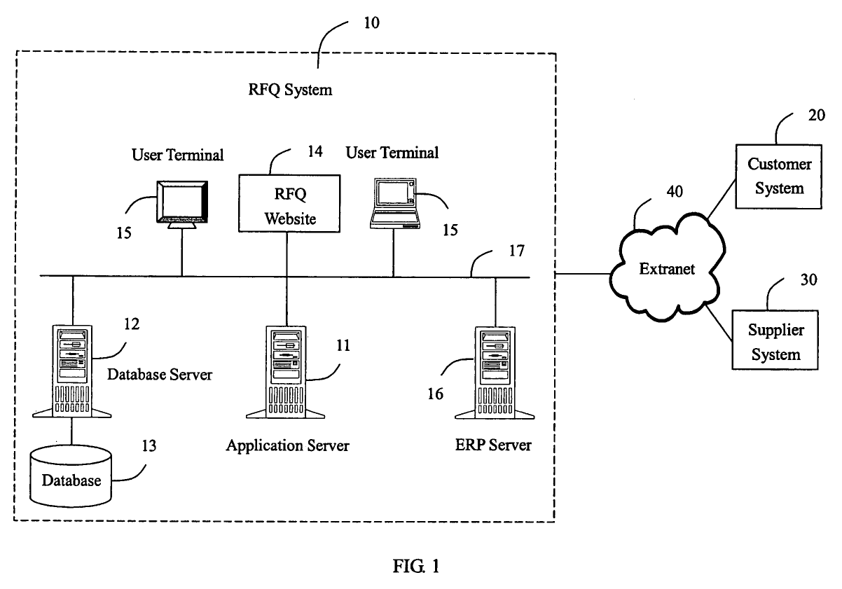

Referring now to the drawings, FIG. 1 illustrates hardware configuration of a request for quote (RFQ) system 10 in accordance with the present invention, together with an application environment of the RFQ system 10. The RFQ system 10 is connected with a plurality of customer systems 20 (only one shown) and a plurality of supplier systems 30 (only one shown) via an extranet 40. The extranet 40 may be any appropriate high-speed communications network known in the art, such as a private network or the Internet. The RFQ system 10 can be operated by any entity that provides goods and/or services required by various customers. In the embodiment described herein, the entity is a manufacturer.

The term “customer” as used herein may be construed to include “consumer” and “buyer,” and refers to any individual, group, business or entity which is interested in purchasing goods and/or services from the manufacturer at reasonable prices. Reasonable price can be taken to mean the best possible price that is acceptable to a customer according to the customer's commercial judgment. Each customer system 20 includes all means that allow the corresponding customer to utilize the RFQ system 10. In particular, each customer system 20 includes a computer with a website browser, which enables the customer to access the Internet. The plurality of customer systems 20 connected to the RFQ system 10 enable different customers to participate in the RFQ process and submit requests for quotes online.

The term “supplier” as used herein includes any vendor that supplies goods and/or services to the manufacturer running the RFQ system 10. Each supplier system 30 includes all means by which the corresponding supplier can utilize the RFQ system 10. In particular, each supplier system 30 preferably includes a computer with a website browser, which enables the supplier to access the Internet. The plurality of supplier systems 30 connected to the RFQ system 10 enable the manufacturer to purchase materials from various different suppliers.

The RFQ system 10 comprises an application server 11, a database server 12, a database 13 connected to the database server 12 through a database connectivity (not labeled), an RFQ website 14, a plurality of user terminals 15, and an ERP (enterprise resource planning) server 16. The above-mentioned devices are interconnected via a line 17. The line 17 represents a means of communication, preferably an electronic network such as a local area network or a wide area network.

The application server 11 includes a plurality of function modules. The function modules are programmed to control and coordinate all the RFQ procedures in the RFQ system 10. The database server 12 controls operations of maintaining information (data) stored in the database 13. Such data includes basic information on various customers and suppliers, RFQ spreadsheets received from the customer systems 20, RFQ reports generated by the application server 11, RFQ responses transmitted to the customer systems 20, and bills of material (BOMs) obtained from the ERP server 16. The RFQ website 14 provides an operating platform for performing RFQ activities, and is accessible to the customers and the suppliers as well as staff of the manufacturer. For example, a customer can submit his/her RFQ spreadsheets to the RFQ system 10 by logging on the RFQ website 14. The user terminals 15 may be general-purpose computer devices such as personal computers, laptops, portable handheld devices (e.g., personal digital assistants), or other suitable computing devices known in the art. Each user terminal 15 has a user interface for staff of the manufacturer to access, control and direct the RFQ system 10. In particular, the staff of the manufacturer can respond to the received RFQ spreadsheets through any one of the user terminals 15. The ERP server 16 provides the application server 11 with information on production management, especially item information comprised in corresponding BOMs which is needed for generating RFQ reports. Item information typically comprises: item name, item number, specifications, supplier name, purchasing price, etc.

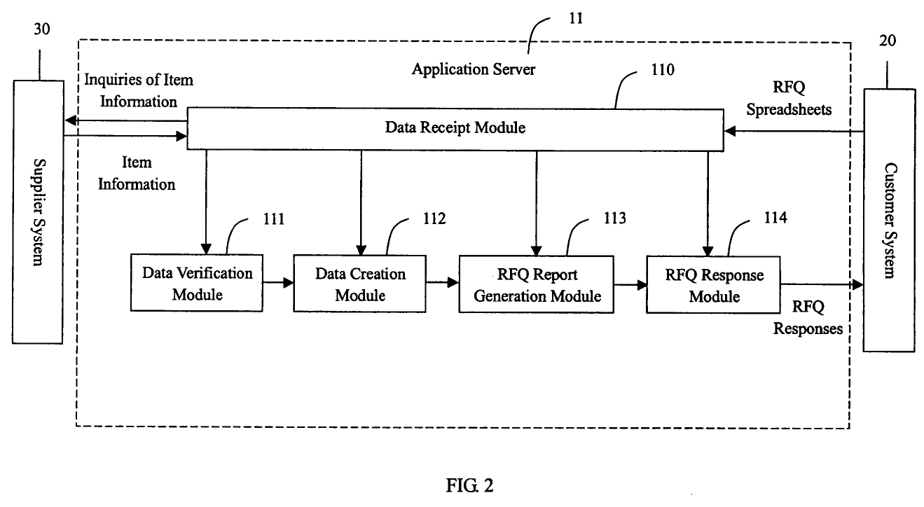

FIG. 2 is a block diagram of function modules of the application server 11, showing data interchange among the function modules and also between the function modules and the customer system 20 and the supplier system 30 of FIG. 1. The application server 11 communicates with the customer system 20 and the supplier system 30 through the extranet 40, and comprises a data receipt module 110, a data verification module 111, a data creation module 112, an RFQ report generation module 113 and an RFQ response transmission module 114. The function modules are all programmable in order to perform various RFQ processes.

The data receipt module 110 receives RFQ spreadsheets from the customer system 20. A typical RFQ spreadsheet includes: customer's identification (code), quote date and time, product name, product quantity, optional product specifications, customer part numbers, shipping method, shipping destination, customer's notes, etc. The optional product specifications may comprise type, size, color and model for a product that the customer wishes to receive a price quote on. The data receipt module 110 can also inquire of item information in the supplier system 30 when information on certain items specified in the RFQ spreadsheets is not available in the BOMs obtained from the ERP server 16, and receive the item information from the supplier system 30.

The data verification module 111 searches for basic customer information stored in the database 13, and determines whether a customer who wishes to purchase goods and/or services is a new one. The data verification module also ascertains whether all item information specified in the RFQ spreadsheets is available in the BOMs.

The data creation module 112 creates an account for a new customer in the RFQ system 10 if the customer is identified as a new one, and creates RFQ numbers according to the RFQ spreadsheets. The RFQ report generation module 113 collects the RFQ spreadsheets, the RFQ numbers and BOMs imported from the ERP server 16 according to customer part numbers comprised in the RFQ spreadsheets, and generates RFQ reports by integrating the collected information. A typical RFQ report comprises fields for: manufacturer identification (code), quote number, quote date, quote expiration, price per unit, total price, taxes, shipping charge, delivery time, manufacturer's notes, etc. The RFQ response transmission module 114 receives responses to the RFQ reports made by staff of the manufacturer, and transmits the RFQ responses to the customer system 20.

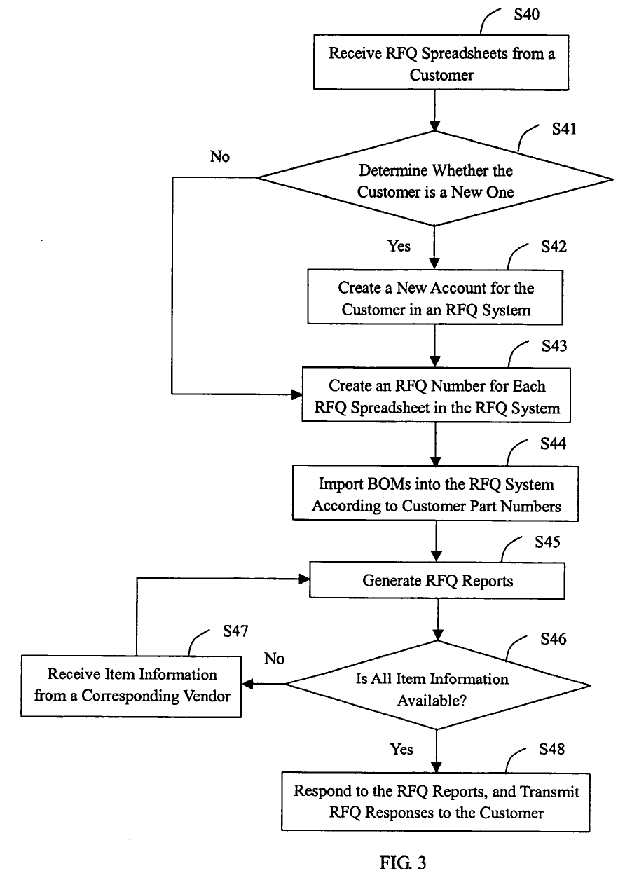

FIG. 3 is a flow chart of a preferred RFQ method, utilizing the RFQ system 10 according to the present invention. In step S40, the customer running the customer system 20 logs on the RFQ website 14, and submits RFQ spreadsheets to the RFQ system 10. The data receipt module 110 receives the RFQ spreadsheets from the RFQ website 14. In step S41, the data verification module 111 determines whether the customer is a new one by searching for basic customer information stored in the database 13. If the customer is an old one, the procedure goes directly to step S43 described below. If the customer is a new one, in step S42, the data creation module 112 creates a new account for the customer in the RFQ system 10 according to basic information on the customer comprised in the RFQ spreadsheets. In step S43, the data creation module 112 creates an RFQ number for each RFQ spreadsheet in the RFQ system 10. In step S44, the data receipt module 110 imports corresponding BOMs from the ERP server 16 according to customer part numbers comprised in the RFQ spreadsheets. In step S45, the RFQ report generation module 113 generates RFQ reports for the customer in accordance with the RFQ spreadsheets, the RFQ numbers and the BOMs. In step S46, the data verification module 111 ascertains whether all the item information comprised in the RFQ reports is available in the BOMs. If all the item information comprised in the RFQ reports is available in the BOMs, the procedure goes directly to step S48 described below. If information on any item in the RFQ reports is not available in the BOMs, in step S47, the data receipt module 110 inquires of the item information in the supplier system 30 that supplies the item. The supplier then transmits the item information to the data receipt module 110, whereupon the procedure returns to step S45. In step S48, staff of the RFQ system 10 respond to the RFQ reports through any one of the user terminals 15. The RFQ response transmission module 114 receives RFQ responses, and transmits the RFQ responses to the customer system 20.

Although the present invention has been specifically described on the basis of a preferred embodiment and preferred method, the invention is not to be construed as being limited thereto. Various changes or modifications may be made to the embodiment and method without departing from the scope and spirit of the invention.

1. A request for quote (RFQ) system incorporating one or more customer systems and one or more supplier systems, the RFQ system comprising an application server, a database server and an RFQ website, the application server being interconnected with the database server and the RFQ website through a means of communication, wherein the application server comprises:
a data receipt module provided for receiving one or more RFQ spreadsheets from said customer systems, and for inquiring of item information in said supplier systems when the item information is not available in the RFQ system;
a data verification module provided for determining whether a customer is a new one, and for ascertaining whether all item information specified in said RFQ spreadsheets is available;
a data creation module provided for creating an account for a new customer, and for creating RFQ numbers according to said RFQ spreadsheets;
an RFQ report generation module provided for generating one or more RFQ reports according to said RFQ spreadsheets, the RFQ numbers and one or more bills of material (BOMs) imported according to customer part numbers comprised in said RFQ spreadsheets; and
an RFQ response transmission module provided for receiving one or more RFQ responses to said RFQ reports, and for transmitting said RFQ responses to said customer systems.

2. The RFQ system according to claim 1, further comprising an enterprise resource planning (ERP) server for providing BOMs which comprise item information specified in said RFQ spreadsheets.

3. The RFQ system according to claim 1, wherein the database server controls operations of maintaining information stored in a database connected to the database server.

4. The RFQ system according to claim 1, wherein the RFQ website provides an operating platform for performing RFQ activities, and is accessible to users of said customer systems and said supplier systems.

5. A computer-based method for processing requests for quotes (RFQs) received from one or more customers by implementing an RFQ system, the method comprising the steps of:
receiving one or more RFQ spreadsheets from said customers;
determining whether any of said customers are new ones;
creating RFQ numbers in the RFQ system according to said RFQ spreadsheets;
importing one or more bills of material (BOMs) into the RFQ system according to customer part numbers comprised in said RFQ spreadsheets;
generating one or more RFQ reports according to said RFQ spreadsheets, the RFQ numbers and said BOMs; and
responding to said RFQ reports, and transmitting one or more RFQ responses to said customers.

6. The RFQ method according to claim 5, further comprising the step of creating an account for any new customer.

7. The RFQ method according to claim 5, further comprising the step of determining whether all item information specified in said RFQ reports is available in a database.

8. The RFQ method according to claim 7, further comprising the step of receiving item information from one or more corresponding suppliers if corresponding item information is not available in the database.

9. A request for quote (RFQ) system incorporating one or more customer systems and one or more supplier systems, the RFQ system comprising an application server including:
a data receipt module provided for receiving one or more RFQ spreadsheets from said customer systems, and for inquiring of item information in said supplier systems when the item information is not available in the RFQ system;
a data verification module provided for ascertaining whether all item information specified in said RFQ spreadsheets is available;
a data creation module provided for creating RFQ numbers according to said RFQ spreadsheets;
an RFQ report generation module provided for generating one or more RFQ reports according to said RFQ spreadsheets, the RFQ numbers and one or more bills of material (BOMs) imported according to customer part numbers comprised in said RFQ spreadsheets; and
an RFQ response transmission module provided for receiving one or more RFQ responses to said RFQ reports, and for transmitting said RFQ responses to said customer systems.
